(19) United States
(12) Patent Application Publication
(10) Pub. No.: US 2024/0235261 A1
(43) Pub. Date: Jul. 11, 2024

(54) PRALLENATOR

(71) Applicant: Brennan Patrick Pralle, La Crosse, WI (US)

(72) Inventor: Brennan Patrick Pralle, La Crosse, WI (US)

(21) Appl. No.: 18/094,373

(22) Filed: Jan. 8, 2023

(51) Int. Cl. H02J 50/10

(52) U.S. Cl. CPC H02J 50/10

(57) ABSTRACT

In an embodiment, the invention of the present disclosure is a highly efficient, pollution free generator of electricity without use of a fuel source, climatic conditions, kineovoltaics, kinetic motion, motors nor permanent magnets. The trademark for this embodiment to be known as the “Prallenator.” Induction is accomplished by utilizing magnetic flux caused by an electrical current to cause potential difference to occur in near proximity to a non-powered conductive material. Connective wiring provides a pathway for induced potential difference to transfer from the non-powered conductive material to an application such as a recharge circuit, power storage device, variable frequency drive or load. The Prallenator is comprised of collector plates, inducing coil wiring, holding brackets, inducing power integrated circuit(s) comprised of connective wiring, circuit boards, capacitors, solid state switches and diodes, actuated by a programmable logic controller that utilizes monitoring sensors, internal memory storage, powered by mediary power circuitry, with digital network communication capability, and an outer housing with open mesh design, POS and NEG outlet terminals.

### BACKGROUND

Generally, electrical generator systems rely upon movement of a conductor within a magnetic field, or, movement of the magnetic field around a conductor. Most generators utilize a rotating magnetic rotor or rotating a conductive armature within a magnetic field.

The omission of motors and magnets in our design classifies our patent category to H02N 11/002, “Generators or motors not provided for elsewhere.”

Current-caused magnetism was first discovered by Hans Christian Oersted in 1820. The density of the magnetic field is dependent upon the amount of current flow and distance of measurement from the conducting material. These phenomena were mathematically derived by Jean-Baptiste Biot and Emile Savart in 1820. Joseph Henry discovered the electromagnetic phenomenon of self-inductance. Michael Faraday's experiments demonstrated the principles underlying electromagnetic induction, diamagnetism and electrolysis. Faraday's observations were expounded upon and derived by James Clerk Maxwell in his 1865 publication of “A Dynamical Theory of the Electromagnetic Field.” An exacting scientific study of the Faraday-Maxwell Law applied to conductors was accomplished by Edward Rosa, “The Self and Mutual Inductances of Linear Conductors,” in 1907.

Our generator is premised upon Maxwell-Faraday's laws of electrical induction which state electromotive force is induced by:
1. Change of magnetic field flux, or
2. Change of conductor area within magnetic field, or
3. Change of magnetic field angle incident upon the area.

Our generator creates the conditions of Maxwell-Faraday's laws of electrical induction by changing the magnetic field flux acting upon an area of conductive material by switching current on and off in a nearby conductor.

### Properties of Magnetic Field Produced by Current Carrying Conductor:

The strength of the magnetic field surrounding a current carrying conductor is directly proportional to the magnitude of current.
A magnetic field induces an electric charge of opposite polarity in an adjacent non-powered conductive material not connected to ground.
The strength of magnetic field at any point is inversely proportional to the distance of the point from the conductor.
The magnetic field encircles the elements. “Element” refers to the conductive material upon which the magnetic field is acting. sides of the induced conductive material has an elements placed side-by-side running along the distance of the length. Current flows in the same direction on both sides of the conductive material's face.
The magnetic field lies in a plane perpendicular to the conductor.
The magnetic field can be reversed by reversing the direction of current in the conductor.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided an electrical microgenerator for producing electricity without use of a fuel source, photovoltaics, kineovoltaics, kinetic energy, motors nor permanent magnets. The trademark for this embodiment to be known as the “Prallenator.” The trademark slogan is, “Own Your Power.”

The electrical microgenerator is comprised of collector plates, holding brackets, wire induction coil, a process power integrated circuit comprised of capacitors, transistor switches, programmable logic controller, internal power supply, electrical characteristics sensors, connective wiring, internal memory storage, power storage device, digital communicating device, and an exterior housing containing output power terminals and status indicator light emitting diodes (LEDs).

Other embodiments are also disclosed.

Additional objects, advantages and novel features of the technology will be set forth in part in the description which follows, and in part will become more apparent to those skilled in the art upon examination of the following or may be learned from practice of technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are in drawings, those being:

FIG. 1 illustrates inducing coil pattern;

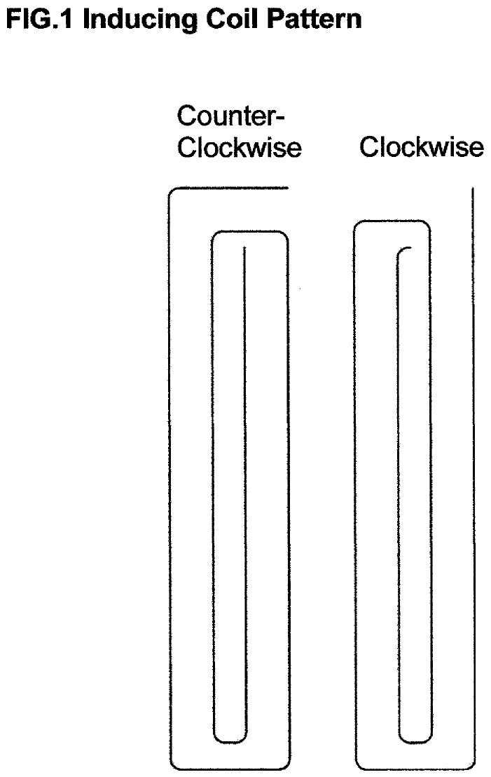

FIG. 2 illustrates holding brackets;

FIG. 3 illustrates equipment function wiring chart;

FIG. 4 power circuit board wiring diagram;

FIG. 5 illustrate exterior housing concept drawing;

FIG. 6 chart of induced potential from experimental observances;

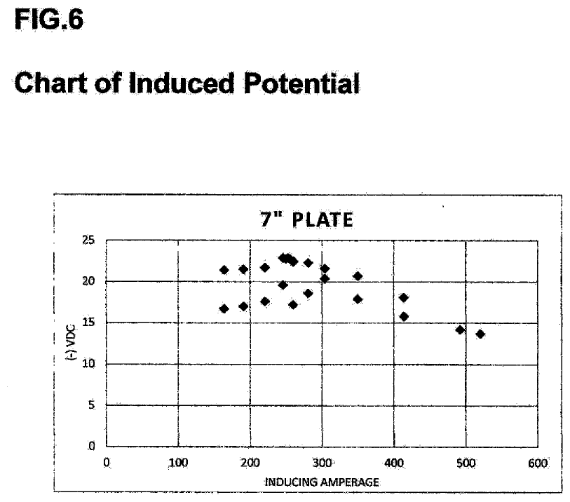

FIG. 7 chart of capacitor charging and discharging curves.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

In an embodiment, there is provided an induction electrical microgenerator for producing electricity without use of a fuel source, photovoltaics, kineovoltaics, kinetic motion, motors nor permanent magnets. The invention of the present disclosure is a highly efficient, pollution free generator of potential difference, amperage. Induction is accomplished by utilizing the magnetic flux density caused by an electrical current to cause potential difference to occur in a non-powered conductive material in near proximity to the magnetic flux. Connective wiring provides a pathway for induced potential difference to transfer from the non-powered conductive material to an application such as a power storage device, variable frequency drive (VFD) or load.

“Prallenator” is a trademark for this novel device.

“Own Your Power” is a trademark slogan for this novel device.

Static Induction Generation: Our generator is a current dependent voltage source. Electrostatically induced conductors remain stationary while the magnetic field changes around them.

The magnetic field lies in a plane perpendicular to the conductor. Inducing coil elements are aligned parallel to the collector plate's height. Inducing coil wiring is looped as many times as is necessary for the sum of the wiring widths to cover the length of the collector plate.

Current flowing through inducing coil elements moves in the same direction as near as possible over the surface area of collector plate faces.

The magnetic field angle of incidence upon collector plates is 45° through 135°.

Maximum inductive effect occurs by holding a non-powered conductive material as near as possible to the current carrying conductor without physical contact. This phenomenon is derived by the Biot-Savart Equation.

Process Power Wiring: We are selecting a copper-carbon alloy (U.S. Pat. No. 9,273,380 B2) for the inducing coil wiring and collector plate material. Explicit permission for use of this material has been given by the patent's owner, Dr. Robert Scherer. Copper is an abundant metal used for fabricating conductors. Copper (Cu 81200) is reworked by means of a continuous manufacturing process, “Composite Materials, Apparatuses and Methods” (U.S. Pat. No. 10,711,327). Explicit permission for use of this process has been granted to the inventor by the patent's owner, Dr. Robert Scherer. Conductive materials that have been reworked by this process are known as “invetal”.

Non-Process Power Wiring: Selection of non-process power connective wiring is in accordance with the American National Standard for Uninsulated Conductors—Used in Electrical and Electronic Applications ANSI/NEMA WC 67-2015 (R2021) and in compliance with the American Wiring Gauge (AWG) standards set forth by the most recent version of the National Fire Protection Association's standard NFPA-70, “National Electric Code.”

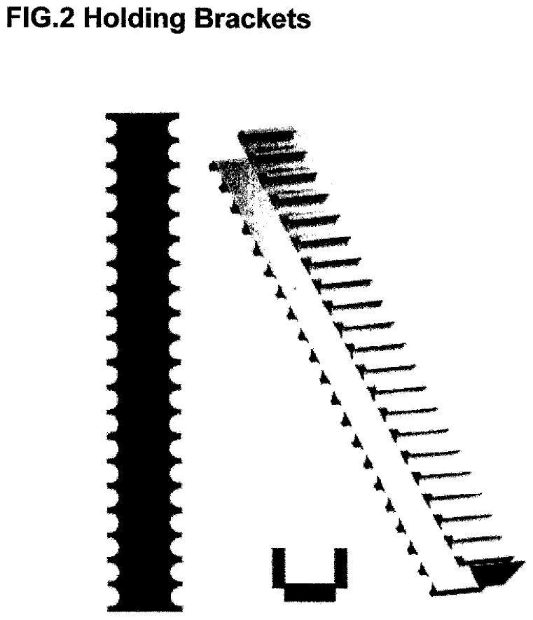

Inducing Coils: With reference to FIG. 2, inducing coils are process power wiring configured in repeating loops shown as clockwise (CW) and counterclockwise (CCW). The loops repeat as many times as necessary for the widths of the wiring to cover the length of the collector plate surface area described below. The gauge of the wiring is selected according to the amount of process power amperage the coil will be conducting and the fusing current maximums given in the NFPA-70.

Collector Plates: collector plates are comprised of a conductive material formed into rectangular shape, width×length×height. The dimensions of the collector plate may vary according to the application design. The conductive material will most likely be a highly conductive metal such as silver or copper. The conductive metal may also involve a carbon alloy as described above. Maximum electric field density is present upon the surface of the collector plate. The ends of the plates have connecting posts or wiring mechanically affixed to plate surface.

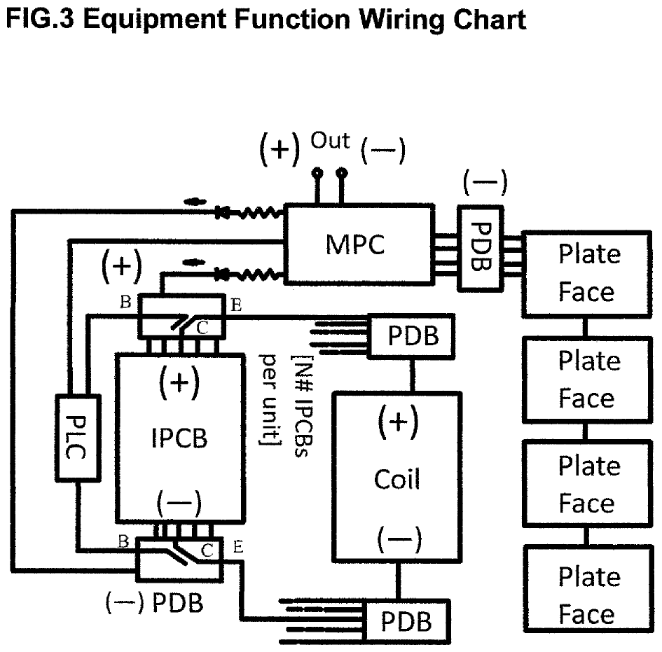

With reference to FIG. 3, inducing coil wiring and collector plates are held in place by holding brackets. The top and bottom edge of the collector plate are held in place by the central groove of the holding bracket. The beginning and end inducing coil wire lengths snap into the semicircular bracket spaces.

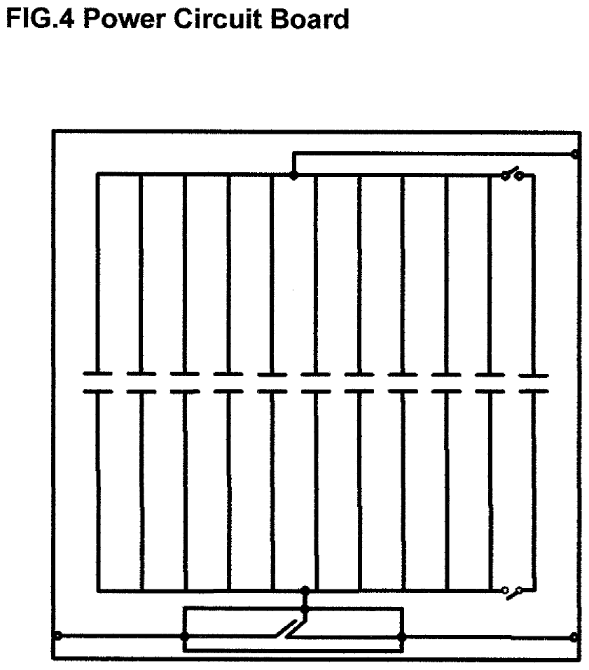

Induction Power Circuit Components: With reference to FIG. 3 and FIG. 4, the induction power circuit is an integrated circuit comprised of capacitors, diodes, connective wiring, solid-state switches, and power distribution blocks. Monitoring sensors, ref: [0040], additional controls and redundant circuitry may be added or left out of assemblies. Specific components selected will vary according to the power application requirements.

Switches: With reference to FIG. 4, the induction power circuit's solid-state switches are transistors selected according to their method of control and input/output ampacity. Examples of transistors include, but are not limited to, insulated gate bipolar transistors (IGBT), Darlington's or metal-oxide-semiconductor field-effect transistors (MOSFET).

Capacitors: With reference to FIG. 4, a power circuit board's capacitors are selected according to their voltage rating, capacitance rating, power storage capacity, inducing coil resistance as well as desired rate of charging and discharging. Examples of capacitors which may be utilized include, but are not limited to, encasements of conductive materials described above and dielectric materials such as ceramics, polypropylene, paper and electrolytics. Capacitors may be of fixed or variable capacitance.

Power Distribution Block (PDB): With reference to FIG. 3, a power block provides connection of multiple charge transfer wires to and from each inducing power integrated circuit. Our example power block is the ENTRELEC DBL400 & DBL250.

Programmable Logic Controller (PLC): With reference to FIG. 3, the induction power circuit's PLC will be selected based upon its control power characteristics, programmability, input/output solid state switches, sensor inputs, operating software, on-board memory and digital communicating interface.

Internal Power Supply: The induction power circuit's controlling power supply is selected according to the input power requirements of the programmable digital controller. The controller can be powered by electrical socket or USB port. Examples of stand-alone, remote power sources include a stepped down transformer with rectifier to direct current, rechargeable battery or induced power through the mediary power circuit. Our example assembly utilizes the Labjack T4 powered by USB 5 Vdc.

Monitoring Devices: Monitoring devices are sensors which monitor the status of the inducing power circuit's voltage, amperage and frequency, wiring temperatures, capacitor levels of charge, internal power supply, cycle counts, time, surge current interrupters as well as the amount of potential difference present on the collector plates and the amperage of charge being transferred from the plates. Other sensors may be added as needed. Sensor information is received and stored internally by the PLC. Sensor information will be periodically communicated via digital wireless signal or Ethernet connection to a database platform.

Charge Transfer Wiring: With reference to FIG. 3, charge is transferred from the collector plate by connective wiring. The wiring is mechanically affixed to the posts or plate surface.

Transfer Wiring Outlet: With reference to FIG. 3, charge transfer wiring connects to a multipin outlet terminal for providing electrical pathway to the power storage device.

Mediary Power Controller (MPC): With reference to FIG. 3, mediary power controller delivers negative and positive polarity charge to Prallenator's output terminals and the recharge circuit. MPC functions are controlled by the PLC. It is comprised of electrical continuity wiring connections, power distribution blocks, solid state switching and power storage devices such as capacitors.

Mediary Power Circuit Board (MPCB): With reference to FIG. 4, mediary power circuit boards are constructed and function similar to the inducing power integrated circuit. The exception being that the MPC capacitors are configured into a unipolar state, connected in parallel, in order to charge transfer wiring outlet. The number of MPCBs, sequencing of discharge and duration of recharge are controlled by the PLC and monitoring sensors.

Power Storage Device: A power storage or other power conditioning device(s) are connected to the outlet terminals. Examples of a power storage device include but are not limited to a rechargeable battery, capacitor(s), connection to external circuitry or a variable frequency drive (VFD). The power storage device delivers the newly created power to the load application.

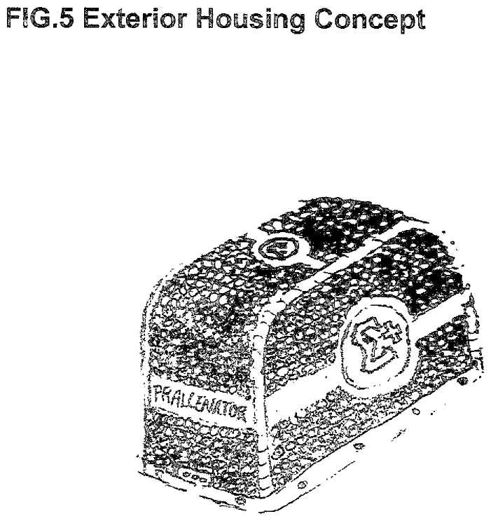

Application Terminals: With reference to FIG. 5, Three terminals are provided on the generator housing. The terminals are marked POS, NEG, and G. POS provides direct current positive charge. NEG provides direct current negative charge. The G terminal connects to ground.

Network Metering: The PLC shall have communicability to securely transmit the requested operating data from its internal storage through shielded wire or encrypted wireless digital signal to a receiving database platform. This communication platform also allows remote access for technical adjustment of PLC operating parameters. Our example assembly utilizes the ethernet cable connections of the Labjack T4.

Exterior Housing: With reference to FIG. 5, the exterior housing will be of rectangular three dimensions. The housing will be perforated in an open mesh pattern so as to embody the necessary net free area to dissipate generated heat loss through natural convection with ambient air. The symbol of the Net Surplus Company will be embossed upon the top surface with the name “Prallenator” written on each side of the housing length. The symbol of the Net Surplus Company will be embossed upon the opposite housing walls enclosing the device's width. The housing shall mount into a circular base which will provide means for mounting to surfaces. LED Status lights are mounted on the exterior housing of our product. LED Status Lights: LED1 (Blue)—Switched on when inducing power circuits and transfer circuits are not in fault. LED2 (Red)—Switched on when inducing power circuits and transfer circuits are in fault. LED3 (Green)—Switched on when inducing power circuit is actuating.

### Function Description

The purpose of this equipment design is to provide point-of-use generation of electricity. The electrical microgenerator is comprised of collector plates, holding brackets, wire induction coil, process power integrated circuits comprised of capacitors, transistor switches, programmable logic controller, internal power supply, mediary power circuit, electrical characteristics sensors, connective wiring, internal memory storage, power storage device, digital communicating device, and an exterior housing containing output power terminals and status indicator light emitting diodes (LEDs).

In reference to FIG. 4, collector plates; two collector plates are composed of highly conductive material such as 99.99% copper alloy (Cu 81200). The dimensions of are seven inches length, seven point five inches height and point seven inches width (7″×7.5″×0.7″). The dimensions and alloys of the collector plate may vary according to application design.

In reference to FIG. 4, inducing coil wiring; example inducing coil wire utilizes Cu 81200 formed to American Wire Gage standard size #8 and enameled to prevent short circuit. The NFPA-70 fusing current for AWG8 wire is 473 A (DC). Negligible heat loss occurs at 200-300 amperes. The lengths are very straight and evenly spaced conductive wire. The example circuit inducing coil has length of one hundred and fifty feet to cover the plate face described in ref: [0049]. The internal resistance of the wiring is seventeen milliohms (0.017 Ohm).

In reference to FIG. 4, inducing power characteristics, our example inducing power has current of two hundred and twenty amperes of direct current (220 Adc). The voltage of the example inducing power circuit is 11.2 volts, direct current (11.2 Vdc).

In reference to FIG. 4, Inducing power source is capacitor discharge. Variant sources of inducing power are discussed herein.

With reference to FIG. 4, inducing power circuit board capacitors and diodes, our example design has ten count, ninety farad (90 F) capacitors, providing nine hundred farads (900 F) of capacitance at 5.6 Vdc, in each inducing power circuit board (ICPB). Capacitor power sources may be a single device, or several wired in series or other integrated circuit patterns. Our example Prallenator has ten (10), 90 F capacitors wired in parallel to produce nine hundred farads (900 F) of capacitance at 5.6 Vdc. Capacitor terminal connecting wires are AWG18. Wiring is affixed by means of electronic solder to each of the capacitors' terminals.

With reference to FIG. 3 and FIG. 4, power distribution busbar or power distribution block (PDB), capacitors' connective wiring from the terminal is received in parallel across a power block. A busbar lands the wires by means of electronic solder upon a common conductive surface. A power distribution block affixes wiring in screw-down metal terminals. Our example PDB has twelve possible inlet terminals. It is suitably rated for inducing power amperage and built to affix the likewise properly sized wire for the current being processed. There are two PDBs with each inducing current power board (IPCB). One PDB outlet wire carries positive charge out and the other PDB provides pathway to negative terminals on the IPCB. Our example circuit uses AWG8 outlet wire from the power block outlet.

With reference to FIG. 3 and FIG. 4, inducing coil power distribution block or busbar, inducing coil inlet and outlet wire connections land at PDB outlets. Each inducing power circuit board's PDB outlet wire lands at an inlet terminals of the inducing coil power distribution block.

With reference to FIG. 3 and FIG. 4, Switching the inducing power circuit board; there are two insulated gate bipolar transistors (IGBTs) per inducing power circuit board. The transistors are switched simultaneously. The collector post for the negative charge carrying IGBT connects to the IPCB's negative power distribution block. The negative IGBT emitter post is connected by wire to one outlet terminal of the inducing coil's outlet power distribution block. The collector post for the positive charge carrying IGBT connects to the IPCB's positive power distribution block. The positive IGBT emitter post is connected by wire to one inlet terminal of the inducing coil's inlet power distribution block, ref: [0056].

With reference to FIG. 3 and FIG. 4, switching control wiring, the transistor biasing terminals are connected by wire to an analog input/output terminal on the PLC. The PLC controls the IGBT gates (B or G) synchronously. The switching rate is determined by the power requirements of the power application (load). The desired switching rate is programmed into the PLC. The duration of forward bias can be defined by control parameters. In our example Prallenator, value parameters for duration are coded into software language to operate switching of gates by means of “If, While, Do” loops operated by the PLC. An example switching duration setting is biasing-forward transistor gates for 480 nano-seconds. The PLC then removes bias voltage for a specified duration.

A duration of time elapses between the biasing voltage signal to IPCBs. A pause duration of a minimum 800 milli-seconds occurs between discharges through the inducing coil. This is the pause duration between sequential discharges of individual inducing power control boards. This pause is necessary to allow induced magnetic fields to fully collapse and induced potential charge to transfer off the collector plate(s). The collector plate returns to charge equilibrium or magnetic neutrality.

With reference to FIG. 4, the next sequential IPCB then makes continuity and discharges its capacitors through the inducing coil. This ripple pattern through inducing power circuit boards proceeds sequentially. When the last IPCB of the sequence discharges, the PLC cycle count adds one. PLC then restarts the cycle through IPCBs. This behavior is repeated in a loop until the PLC is told to stop the cycle or a safety interrupt occurs.

With reference to FIG. 3 and FIG. 4, the number of inducing power circuit boards per Prallenator is determined by the amount of time it takes for the capacitor to recover 98% charge. Example, three IPCBs discharge 1% of stored power between polarity terminals for 0.15 seconds (15 ms) each. The time to recharge 1% of stored power is 0.45 seconds. Three IPCBs are connected to inducing coil power block inlet terminals. A fourth IPCB board is added to give redundancy and slack time for recharging.

Inducing power current bursts through the inducing coil in a stepped waveform. The inducing power is direct current and positive in polarity. A negative polarity electrical charge of potential difference (volts) forms within the collector plates.

The quantity and intensity of induced charge upon the collector plates over a given period of time is driven by the number of times the magnetic field is established and collapses during this duration as well as the intensity of the inducing current. The faster the switching, the more charge is produced (Coulombs) and transferred from the collector plates (Amperage).

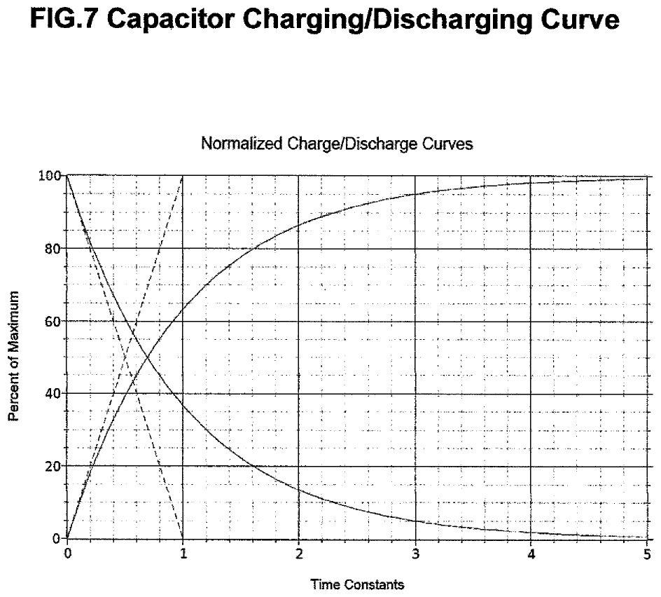

With reference to FIG. 7, lifespan of power circuit components, It is unlikely that a capacitor will ever discharge more than a fraction of 1% of total stored charge before continuity is broken. Lifespan of power circuit components will be extended by limiting the durations of discharge and extending the duration of recharge. For example, the resistive-capacitance (RC) time constant for our example inducing power circuit is found by multiplying the circuit resistance (0.17 Ohm) by circuit capacitance 900 Farads. An example RC time constant is 5.1 seconds. Five resistance-capacitance 25.5 seconds. 1% of total power stored is discharged in 0.255 seconds. This becomes the capacitors' maximum discharge duration. Switching durations ranges could throttle from 480 nano-seconds to 0.255 milliseconds.

With reference to FIG. 3, collector plate potential differences; each collector plate becomes tensioned with negative polarity potential difference. Each plate face is configured by means of electrical continuity connection to transfer this charge individually, in series, or received in parallel at a power block or busbar. In our example Prallenator, a negative potential of seventeen point six volts (17.6 Vdc) is induced upon each collector plate face, ref: [0052].

With reference to FIG. 3, induced power transfer circuit wiring, recharge circuit provides induced negative charge a transfer pathway from the collector plates to the mediary power controller (MPC). Charge transfer wires are electromechanically affixed to the collector plate face surface. The other end lands at the mediary power block (MPB). An MPB could be a collector plate, busbar, power block or other multipin connector.

With reference to FIG. 4, mediary recharge circuit; the flow of input negative charge is bifurcated between the negative output terminal on the equipment housing, and, the MPC recharge circuit. The mediary power circuit utilizes nonpolarized capacitors to receive negative charge from the MPB. Mediary Power Circuit Boards (MPCBs) receive the MPB's output power into parallel, nonpolarized, capacitor circuits. Negative potential difference is transferred from the collector plates to terminals on one side of the capacitor. This side of the capacitor becomes negatively polarized. A corresponding positive charge magnetically forms on the other side of the capacitor. MPCB output terminals are connected to a IGBT collector post. The emitter is affixed by wire to the positive outlet terminal on the equipment housing, and, to the IPCB positive power distribution block. The PLC drives the positive outlet IGBT gate in and out of forward bias.

With reference to FIG. 3, mediary recharge circuit; the flow of input negative charge is bifurcated between the negative output terminal on the equipment housing, and, the MPC recharge circuit. The mediary power circuit utilizes nonpolarized capacitors to receive negative charge from the MPB. Mediary Power Circuit Boards (MPCBs) receive the MPB's output power into parallel, nonpolarized, capacitor circuits. Negative potential difference is transferred from the collector plates to terminals on one side of the capacitor. This side of the capacitor becomes negatively polarized. A corresponding positive charge magnetically forms on the other side of the capacitor. MPCB output terminals are connected to a IGBT collector post. The emitter is affixed by wire to the positive outlet terminal on the equipment housing, and, to the IPCB positive power distribution block. The PLC drives the positive outlet IGBT gate in and out of forward bias.

The difference between IPCB and MPC biasing voltage control is the mediary IGBT gates are biased according to a condition being monitored by the PLC rather than a timed event. The PLC has a hall sensor monitoring inducing power current through the inducing coil. The PLC biases the input mediary IGBT gate while the hall sensor is detecting a current. When the hall sensor does not detect current, the PLC biases the output mediary IGBT gate.

With Reference to FIG. 3 and FIG. 4, the positive polarity power discharge coming out of the MPC recharges the positive terminals of the IPCBs' capacitors. A potentiometer is connected in series between the MPC and a diode. The potentiometer regulates voltage to the rating of the IPCB capacitors. A current backflow preventing diode is connected in series between the potentiometer and the ICPB's power block. The diode is suitably rated to prevent inducing power from being sent to the mediary power controller. Mediary power wiring is landed at the individual IPCB power block in similar fashion as described above.

Prallenator electrical output is in the form of alternating stepped waves of direct current power. The waveform characteristics can be further finessed by manipulating biasing control voltage. For example, biasing voltage could incrementally increase (fade in) or decrease (fade out). Partial bias limits the amount of power being sent through the IGBT. A sinusoidal waveform could be produced in this manner. Further, IGBTs could be held at a constant voltage just below the saturation threshold to increase switching speed which in turn would increase amperage.

Multiple embodiments of the invention of the present disclosure are contemplated according to the requirements of the intended application. Our example herein has been describing a design for application to a rechargeable battery or variable frequency drive. Other applications include but are not limited to; electromotive vehicles with or without batteries, motors, equipment, integrated multiple capacitor circuits, supercomputing, remote generation and power storage.

A variant design is being contemplated which in another embodiment, wiring and collector plates are comprised of superconductive alloys such as graphene-aluminum or graphene-silver.

A variant design is being contemplated which in another embodiment, integrates in generator design multiple inducing power circuits, inducing coils, collector plates, holding brackets in series, parallel or sequenced discharge out of phase from each other to meet the requirements of the power application.

A variant design is being contemplated which in another embodiment, the inducing power control circuit is replaced by means of an amperage step-up transformer connected to rectifiers connected to the inducing power coil circuitry and terminating into an inverting integrating circuit which then returns the process power to its source. For example, returned to power transmission grid. VFD switching to harmonize with grid stability.

A variant design is being contemplated which in another embodiment, a variable frequency drive (VFD) is integrated into the device prior to the outlet terminals. The VFD would receive inlet stepped waveforms and deliver sinusoidal alternating power waveforms as required by the application.

In various embodiments, different output power characteristics can be attained by changing inducing coil and collector plate conductive alloys, power integrated circuits utilizing capacitors or transformers with rectifiers and inverters, collector plate volume and dimensions, the inducing coil wire size, length, number of repeating coil loops, the number of transfer wires, power blocks or busbars, transistor switching rate settings, programmable digital controller functionality, device monitoring instrumentation and power storage device(s) connected to the charge transfer outlet.

The invention of the present disclosure is a novel microgeneration process. No similar generators with a similar composition and function have been found to exist.

The Prallenator is unique in the use of stationary, current-produced magnetic flux to induce electric field in a stationary conductor for the purposes of generating new electrical charge. It is unique in the use of timing the making and breaking of inducing current to create desired intensity of new electrical charge. It is unique in that a single configuration of components can produce many varieties of power characteristics by altering inducing power circuit switching duration. It is unique in that it does not utilize an active method of cooling device components. It is unique in that it is designed to operate without the use of a motor, permanent magnets, fuel, outside power source, nor climatic conditions.

Although the above embodiments have been described in language that is specific to certain structures, elements, compositions, and methodological steps, it is to be understood that the technology defined in the appended claims is not necessarily limited to the specific structures, example elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. An electrical microgenerator for creating potential difference without combustion, photovoltaics, kineovoltaics, kinetic motion, permanent magnets nor motors. The electrical microgenerator comprising of:
an inducing coil(s) that are conductive wires configured in repeating loops shown as clockwise (CW) and counterclockwise (CCW),
a collector plate(s) that are comprised of a conductive material such as silver or copper which may be worked into a rectangular shape,
a holding bracket(s) which affix inducing coil wiring and collector plates in a permanent position,
an induction power circuit(s) that is an integrated circuit comprised of solid-state switches, capacitors, power distribution block(s) or busbar(s), control-power supply, programmable logic controller (PLC), diodes and connective wiring,
a process monitoring schema reading the inducing power circuit's voltage and amperage, wiring temperatures, capacitor levels of charge, surge current interrupters as well as the amount of potential difference present on the collector plates and the amperage of charge being transferred from the collector plates,
a charge transfer wiring circuit that provides an electrical pathway from the collector plates to a mediary power circuit, to an voltage correcting potentiometer with termination at a diode protected connection to capacitor terminals,
a communicating device configured to periodically transmit monitoring information to database applications and allow for remote adjustment of control parameters,
and an exterior housing configured in an open latticed design to allow convection heat transfer.

2. An electrical microgenerator for creating potential difference as in claim 1, wherein said inducing power control circuit is replaced by means of an amperage step-up transformer connected to rectifiers connected to the inducing coil circuitry and terminating into an inverting integrating circuit which then returns the process power to its source.

3. An electrical microgenerator for creating potential difference as in claim 1, wherein said output power characteristics can be altered by changing conductive material alloys, power circuit capacitors, collector plate alloy and dimensions, the inducing coil wire size, length and number of repeating loops, the number of transfer wires, transistor switching rate(s), programmable digital controllers' software coding, power storage device(s) or variable frequency drive connected prior to the power outlet terminals.
